(19) United States
(12) Patent Application Publication
(10) Pub. No.: US 2005/0072594 A1
(43) Pub. Date: Apr. 7, 2005

(54) Electrical wiring device system

(75) Inventor: Richard Gray, New Orleans, LA (US)

Correspondence Address: C. EMMETT PUGH, 82 N. MAIN ST., SUFFIELD, CT, 06078-2102, US

(73) Assignee: RICHARD GRAY's POWER COMPANY (Louisiana LLC)

(21) Appl. No.: 10/830,249

(22) Filed: Apr. 21, 2004

Related U.S. Application Data
(60) Provisional application No. 60/464,281, filed on Apr. 21, 2003.

(51) Int. Cl. H01B 9/02

(52) U.S. Cl. 174/108

(57) ABSTRACT

Electrical wiring devices for audio/video systems, such as, for example, audio speaker cables (FIG. 1), audio/video component interconnect cables (FIG. 2) and power cables (FIG. 3) and the like, and more particularly the structure thereof using, preferably, a series of four, inner, parallel, longitudinally extended or straightly-laid, individually insulated, core wires (11/111/211) surrounded by at least one set [two 220 & 230 for a power cord (200)] of four, spiral wound, outer, individually insulated wires (21/121/221), typically with an initial covering of electrical tape type or paper tape material covered by aesthetic silk or cotton cloth or other material(s), in which the inner, core wires are signal carrying wires and the spiral wound wires are the ground/neutral wires, each type combined at their ends (12A/112A/221A) at terminating end elements, such as twisted ends, RCA-connectors or A/C power plug ends (14/114/214, respectively).

### TECHNICAL FIELD

The present invention relates to wiring or cabling, such as for example, audio speaker cables, audio interconnect cables and power cords and the like, and more particularly to the structure thereof using, preferably, a series of individually insulated, parallel, straight, longitudinally extended, inner wires electrically connected together at both of their respective ends, surrounded by a series of individually insulated, multiple, spiral wound, outer wires, likewise electrically connected together at both of their respective ends, in which the inner wires are signal carrying wires, and the outer wires are grounded with respect to the signal. The composite cable or wiring device typically also has an over-all covering and terminal elements. The power cord version also has a further series of individually insulated, multiple, spiral wound, outer wires, likewise electrically connected together at both of their respective ends, for serving as the neutral line in a three wire or line A/C circuit. The ideal number of wires in each series is four in both the inner core and the outer spiral windings. The spiral wound conductors have a somewhat open spiral, that is, not touching spirals, for example, one encirclement every six to ten inches or more of length.

### BACKGROUND ART

The prior art of audio cable connectors and power cords is replete with very expensive wiring devices of questionable efficacy, particularly for the price.

The present invention is designed to provide a much better “sounding” (more accurate signal transmission) in audio connectors (high level & low level) or power cords and the like.

### GENERAL DISCUSSION OF INVENTION

Thus, the present invention relates to wiring or cabling, such as for example, audio speaker cables, audio interconnect cables, power cords and the like, and more particularly to the structure thereof using, preferably, a series of individually insulated, parallel, straight, longitudinally extended, inner wires, ideally four wires, electrically connected together at both of their respective ends, surrounded by a series of individually insulated, multiple, spiral wound, outer wires, likewise ideally four wires, electrically connected together at both of their respective ends, in which the inner wires are signal carrying wires, and the outer wires are grounded with respect to the signal. The composite cable or wiring device typically also has an over-all covering and terminal elements.

The power cord version also has a further series of individually insulated, multiple, spiral wound, outer wires, likewise ideally four in number electrically connected together at both of their respective ends, for serving as the “neutral” line in a three wire or line A/C circuit. The two sets of spiral wound wires can be spirally wound together, with the wire groups being located next to or along side one another and preferably are not overlapped with each other.

As noted, the ideal number of wires in each series is four in both the inner core and the outer spiral windings. The spiral wound conductors have a somewhat open spiral, that is, not adjacent spirals, for example, one encirclement every six to ten (6″-10″) inches or more of length.

The gauge of the individual inner and outer wires for the speaker wire version and the power cord version is about, for example, fourteen gauge, while the preferred gauge of the inner and outer wires of the audio interconnect version is about twenty-two to about twenty-four gauge, with the inner wires preferably having stranded inner cores and the outer wires preferably having solid conductive cores.

Although the specifics above are preferred or ideal based on the limited tests to date, significant variation is also possible, with multiple, inter-related factors being present, including number of wires, wrap spacing, nature of wires (insulation material and its thickness, conductive material, including the conductive material itself and gauge), etc.

Such embodiments produce better “sounding” cables or wiring devices.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers, and wherein:

FIG. 1 is a side, inner view of a first, exemplary embodiment of the electrical wiring device of the present invention, as might be used, for example, as a high fidelity (hi-fi) speaker connecting wiring cable showing the multiple, inner, straight conductors and the spiral-wound, multiple, outer conductors, with no specific end connectors and no outer wiring cover shown for simplicity purposes; while

FIG. 1A is an end view of the inner conductors of the wiring device of FIG. 1.

FIG. 2 is a side, inner view of a second, exemplary embodiment of the electrical wiring device of the present invention as might be used, for example, as a audio component wiring cable using RCA phono plug connectors at its ends, with no outer wiring cover shown for simplicity purposes; while

FIG. 2A is an end view of the inner conductors of the wiring device of FIG. 2.

FIG. 3 is a side, generalized view of a third, exemplary embodiment of the electrical wiring device of the present invention as might be used, for example, as a power cord using three prong power plug connectors at its ends, with no outer wiring cover shown for simplicity purposes; while

FIG. 3A is an end view of the inner and outer conductors of the wiring device of FIG. 3.

FIGS. 4A, 4B & 4C are oscilloscope screen views showing the effects of the wiring devices of FIGS. 1, 2 & 3, respectively, on a square wave input.

### MODES FOR CARRYING OUT THE INVENTION

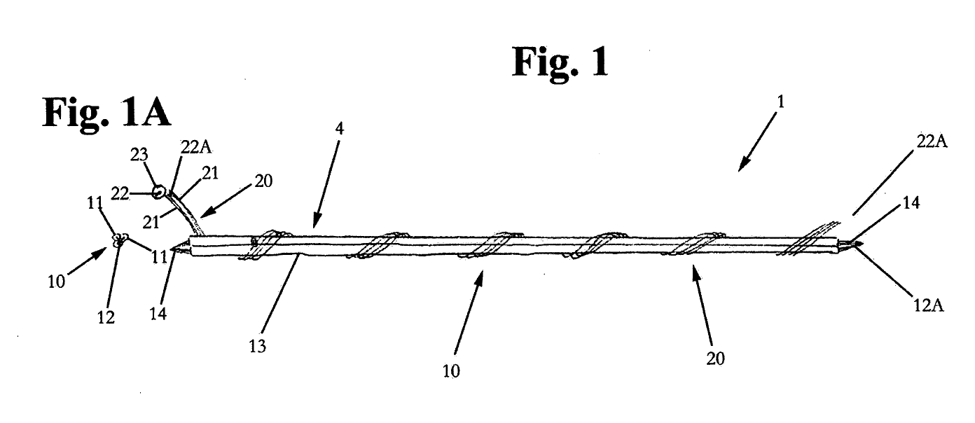

### 1^{st}, Speaker Wire Embodiment (FIG. 1)

As can be seen in FIGS. 1 and 1A, the initial, exemplary, hi-fi speaker connecting wire embodiment 1 of the electrical wiring device of the invention includes an inner set 10 of parallel, straightly-laid, multiple conductors 11, totaling, for example, preferably four, inner conductors 11, roughly forming a square in cross-section (as shown in FIG. 1A). It is preferred that each conductor 11 has it own individual electrically insulating covering. Thus, each of the preferably jacketed conductors 11 has an inner, electrically conductive center 12 with preferably an outer, insulating cover 13. The four, inner conductors 11 can be, for example, stranded copper wire of about fourteen (14 g) gauge and are connected together at their common ends 12A for connection at one end to the “hot” speaker terminal and at the other end to the “hot” amplifier or receiver speaker connection.

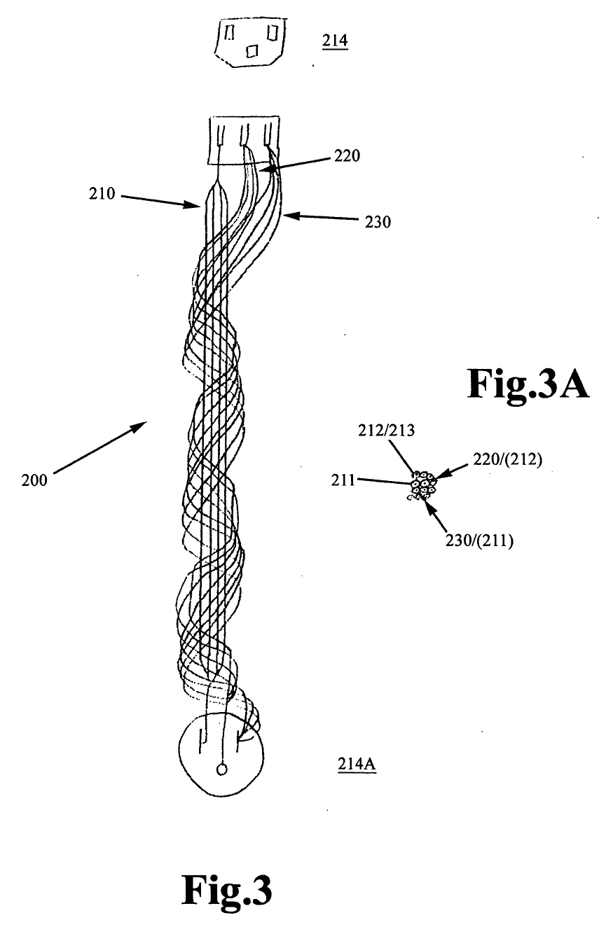

With respect to speaker cable 1 (as well as the power cord 200, described more fully below in connection with FIG. 3), significantly larger or smaller gauge wire, particularly larger wires, provided poorer results. However, even though the type of wire used is important, the type of wrap is even more important for the outer set 20 of spiral wound wires 21, which spiral wrap is described more fully below.

Of course, besides terminating in the exposed, stranded, twisted wire ends 12A twisted together to form terminating ends 14, other suitable wire end components could be used by, for example, soldering or mechanically connecting spade lugs, or banana or other plugs at the ends 12A, if so desired.

Surrounding the inner, straight conductors 11 is at least one, spirally wound set or group 20 of multiple, outer conductors 21, totaling, for example, preferably four, outer conductors 21. Each of the conductors 21 has an inner, electrically conductive center 22 with preferably an insulating cover 23. The four, outer conductors 21 can be, for example, stranded copper wire of about fourteen (14 g) gauge and are electrically connected together at their respective common ends 22A for connection to the other speaker terminal or, at the opposite end to the corresponding speaker connection at the receiver or amplifier end, maintaining a common phase among the various speakers (left, right, center, sub-woofer, surround, etc.).

The outer set or group 20 of conductor wires 21 are spirally wound, preferably not overlapped with respect to one another but rather side-by-side, about the inner set 10 of conductors 11 in a rather open spiral, that is, with the spirals not being tightly packed close or adjacent to one another but rather being somewhat spread out. An exemplary spiral wrap for the exemplary wire size is about one turn to the left for every about six to ten (6″-10″) or more inches of length measured along the longitudinal extent or length of the inner wire set or group 10 (i.e., the wrap spacing), with a turn every about eight (8″) inches or about every ten (10″) inches being exemplary.

The combined inner conductors 11, preferably combined at their ends 14 by being twisted together, preferably are dedicated to carrying the signal to be transmitted through the wiring device 1, while the outer conductors 21 preferably are used for ground. For balanced applications the inverted and non-inverted signals are carried in totally separate cables or wiring devices 1.

An outer cover (not illustrated for simplicity purposes) is placed over the combined conductor sets 10/20 for protection and finish to the wiring device. Such a covering can be made, for example, of vinyl electrical tape covered by silk or cotton cloth, as well as other materials or a combination of materials. The electrical type also serves to hold the composite, straight and spirally wrapped wires together. It is currently believed that an outer cover made of heat shrink tubing or rubber molded is not recommended as those materials would, it is currently believed, deteriorate the quality of the signal being transmitted.

For a single-ended interconnect, one assembly 10/20 is used per channel, while for balanced interconnects, two assemblies 10/20 are used.

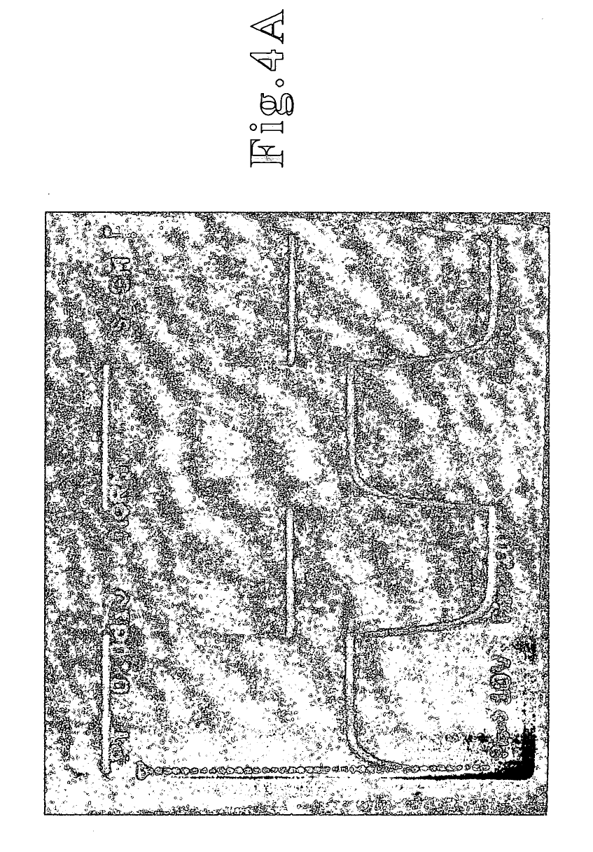

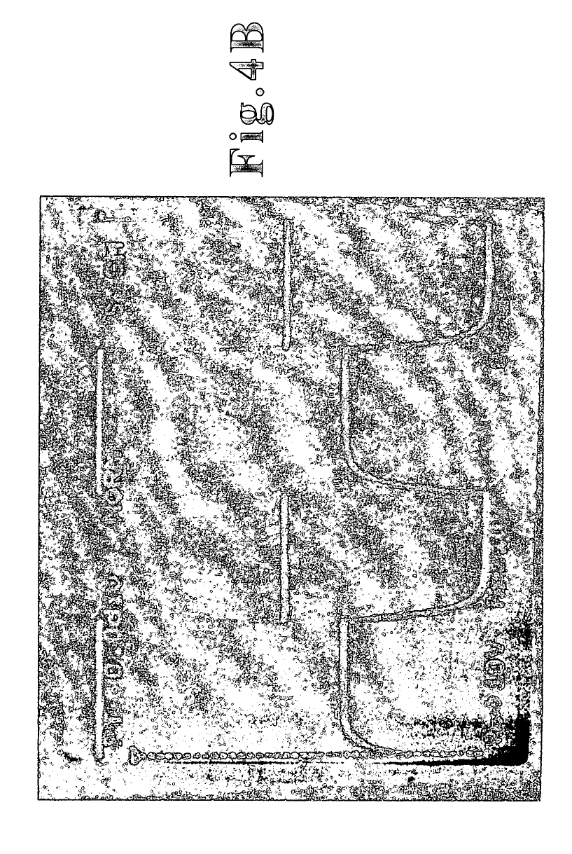

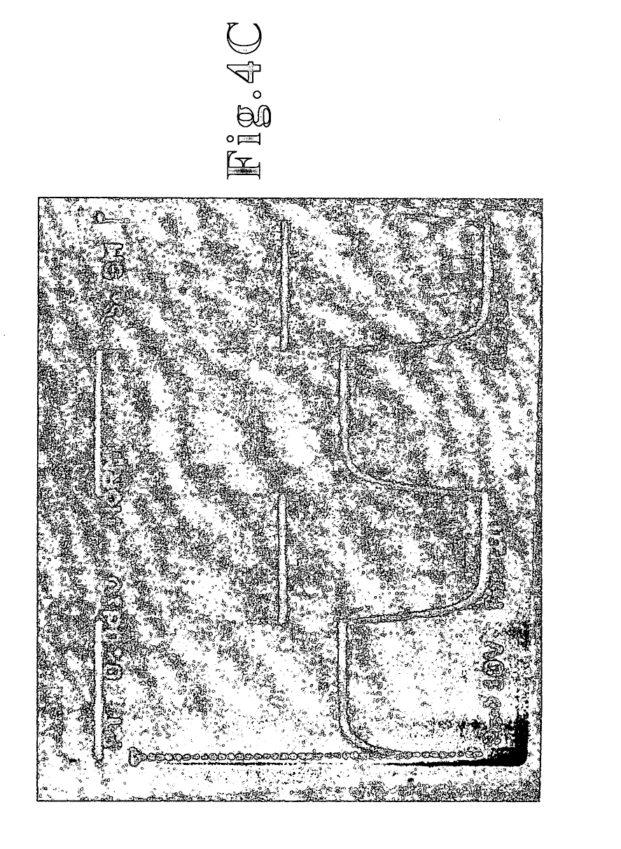

Prototype speaker wire 1 was assembled on a jig to the inner conductor wires 11 straight and tight, while the outer conductor wires 21 were hand-wrapped in the spiral fashion described above. Some test work was done on the wire 1 and is discussed more fully below in connection with FIG. 4A.

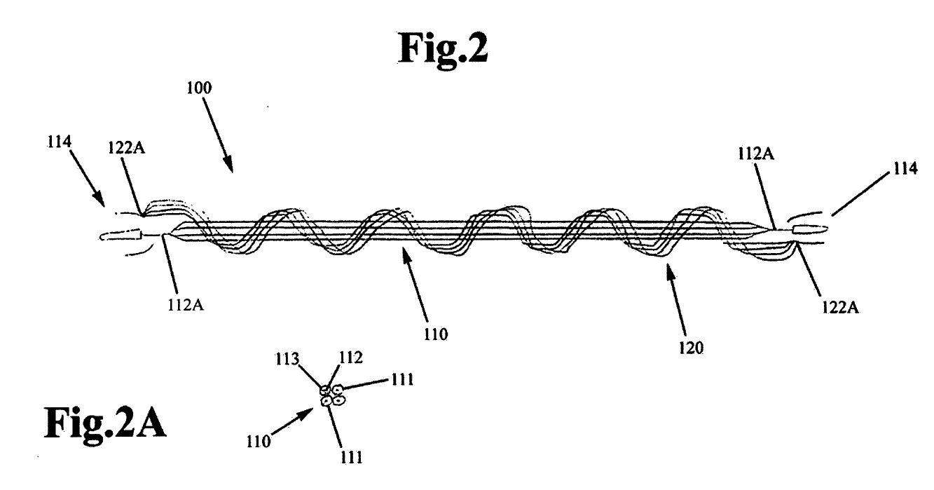

### 2^{nd}, Audio Component Connecting Wire Embodiment (FIG. 2)

As can be seen in FIGS. 2 and 2A, a second, exemplary, audio component connecting wire embodiment 100 of the electrical wiring device of the invention includes an inner set 110 of parallel, straightly-laid, multiple conductors 111, totaling, for example, preferably four, inner conductors 111, roughly forming a square in cross-section (as shown in FIG. 2A). It is preferred that each conductor 111 has it own individual electrically insulating covering made, for example, of nylon or plastic or other suitable material.

Thus, each of the preferably jacketed conductors 111 has an inner, electrically conductive center 112 with preferably an outer, insulating cover 113. The four, inner conductors 111 can be, for example, stranded copper wire of about twenty-two to about twenty-four (22-24 g) gauge, such as that available from Consolidated Cable Company, as well as many other sources, with relatively lower capacitance being more desired. The inner conductors are connected together at their common ends 112A to, for example, the central, male signal pin element of an “RCA” phono plug ending 114 or other suitable terminating element, as may be desired.

Surrounding the inner, straight conductors 111 is at least one, spirally wound set 120 of multiple, outer conductors 121, totaling, for example, preferably four, outer conductors 121. Each of the conductors 121 has an inner, electrically conductive center 122 with preferably an insulating cover 123 of, for example, nylon or plastic. The four, outer conductors 121 can be, for example, solid copper wire of about twenty-two to about twenty-four (22-24 g) gauge and are connected together at their common ends 122A to, for example, the outer, surrounding, shield element of an “RCA” phono plug ending 114 or other suitable terminating element, as may be desired.

The outer set 120 of conductor wires 121 are spirally wound, preferably not overlapped with respect to one another, about the inner set 110 of conductors 111 in a rather open spiral, that is, with the spirals not being tightly packed close or adjacent to one another but rather being somewhat spread out. An exemplary spiral wrap for the exemplary wire size is about one turn to the left for every about six to ten (6″-10″) or more inches of length, measured along the longitudinal extent or length of the inner wire set or group 10 (i.e., the wrap spacing), with a turn every about eight (8″) inches or about every ten (10″) inches being exemplary.

The combined inner conductors 111 preferably are dedicated to carrying the signal to be transmitted through the audio component, interconnect, wiring device 100, while the outer conductors 121 preferably are used for ground. For balanced applications the inverted and non-inverted signals are carried in totally separate cables or wiring devices 100.

An outer cover (not illustrated for simplicity purposes) is placed over the combined conductor sets 110/120 for protection and finish to the wiring device 100. Such a covering can be made, for example, of vinyl electrical tape covered by silk or cotton cloth, as well as other materials or a combination of materials. The electrical type also serves to hold the composite, straight and spirally wrapped wires together. It is currently believed that an outer cover made of heat shrink tubing or rubber molded is not recommended as those materials would, it is currently believed, deteriorate the quality of the signal being transmitted.

Some exemplary uses for the audio component interconnect wiring device 100 are interconnecting components such as the audio portion of VCR recorders/players, phonographs, tape devices, video devices, satellite receivers, cable boxes, etc., to a receiver or pre-amplifier, etc.

For a single-ended interconnect, one assembly 110/120 is used per channel, while, for balanced interconnects, two assemblies 110/120 are used.

Prototype audio interconnect wire 100 was assembled on a jig to the inner conductor wires 111 straight and tight, while the outer conductor wires 121 were hand-wrapped in the spiral fashion described above. Some test work was done on the wire 100 and is discussed more fully below in connection with FIG. 4B.

### 3^{rd} Power Cord Embodiment (FIG. 3)

As can be seen in FIGS. 3 and 3A, a third, exemplary embodiment of the electrical wiring device of the invention in the form of an electrical power cord wiring device 200 includes an inner set 210 of parallel, straightly-laid, multiple conductors 211, totaling, for example, preferably four, inner conductors 211, roughly forming a square in cross-section (as shown in FIG. 3A). It is preferred that each conductor 211 has it own individual electrically insulating covering. Thus, each of the preferably jacketed conductors 211 has an inner, electrically conductive center 212 with preferably an outer, insulating cover 213. The four, inner conductors 211 can be, for example, stranded copper wire of about fourteen (14 g) gauge and are connected together at their common ends 212A to, for example, the line element “L” of a three prong “IEC” (International Electrotechnical Commission) plug ending 214/214A or other suitable terminating, electrical component, as may be desired.

Surrounding the inner, straight conductors 211 is a first, spirally wound set 220 of multiple, outer conductors 221, preferably not overlapped, totaling, for example, preferably four, outer conductors 221. Each of the conductors 221 has an inner, electrically conductive center 222 with preferably an insulating cover 223. The four, outer conductors 221 can be, for example, solid copper wire of about fourteen (14 g) gauge, such as that available from Consolidated Cable Company, and are connected together at their common ends 222A to, for example, the ground or grounding element “G” of a three prong “IEC” (International Electrotechnical Commission) plug endings 214/214A or other suitable terminating, electrical component, as may be desired.

Also surrounding the inner, straight conductors 211 is a second, spirally wound set 230 of multiple, outer conductors 221, totaling, for example, preferably four, outer conductors 221. Like the first set 220 each of the conductors 221 has an inner, electrically conductive center 222 with preferably an insulating cover 223. The four, outer conductors 221 of the second set 230 likewise can be, for example, solid copper wire of about twenty-two (22 g) gauge and are connected together at their common ends 222A to, for example, the neutral element “N” of the three prong “IEC” (International Electrotechnical Commission) plug endings 214/214A or other suitable terminating, electrical component, as may be desired. As can be seen in FIG. 3, one end of each of the conductor sets 210, 220 & 230 are connected to the female plug end 214 of the A/C IEC plug, while the other, respective ends are connected to the male plug end 214A of the A/C IEC plug.

Each of the outer sets 220& 230 of conductor wires 221 thus are spirally wound about the inner set 210 of conductors 211 in a rather open spiral, that is, with the spirals not being tightly packed close or adjacent to one another but rather being somewhat spread out, with one spiral set 220 of four conductors 221 being together and next to the other set 230, directly along side one another, as shown, or spaced from one another, with each spiral of each set being spaced about, for example, four (4″) inches apart. An exemplary spiral wrap for each set 220 & 230, either together as illustrated, or spaced, for the exemplary wire size is about one turn to the left for every about six to ten (6″-10″) or more inches of length, measured along the longitudinal extent or length of the inner wire set or group 10 (i.e., the wrap spacing), with a turn every about eight (8″) inches or about every ten (10″) inches being exemplary, preferably without any overlapping of any of the outer wires 221 with respect to themselves, but rather each laid side by side with the others.

The combined inner conductors 211 thus preferably are dedicated to carrying the line or “hot” signal to be transmitted through the power cord, wiring device 200, while one set (e.g. set 220) of outer conductors 221 preferably is used for ground “G” and the other set (e.g. set 230) is used for neutral “N.” For balanced applications the inverted and non-inverted signals are carried in totally separate cables or wiring devices 200.

It is noted that, with respect to the use of either solid or stranded, conductive material for the inner, conductor wires 22/122/222, the outer conductors preferably are solid copper on low level interconnects 100 but not for the speaker wires 10 or the power cords 200, which preferably are all stranded copper or other suitable conductive material. On the interconnects 100 the inner conductive material 112 is preferably stranded, as it carries the signal, in comparison to the outer ones which are grounded. With respect to power cords 200 current carrying requirements typically dictate the use of all stranded material.

An outer cover (not illustrated for simplicity purposes) is placed over the combined conductor sets 210/220/230 for protection of and finish to the wiring device 200. Such a covering can be made, for example, of vinyl electrical tape covered by silk or cotton cloth, as well as other materials or a combination of materials. The electrical type also serves to hold the composite, straight and spirally wrapped wires together. It is currently believed that an outer cover made of heat shrink tubing or rubber molded is not recommended as those materials would , it is currently believed, deteriorate the quality of the signal being transmitted.

Some exemplary uses for the power cord, wiring device 200 are connecting the power supplies of audio video components such as TVs, VCR recorders/players, phonographs, tape devices, video devices, DVD recorders/players, satellite receivers, cable boxes, pre-amplifiers, receivers, amplifiers, computers, computer components, etc., or, for that matter, practically any AC device or appliance, etc., to the AC power line or power supply or other, supplemental, power devices, such as, for example, the inventors' “Richard Gray's Power Company™” power device described in U.S. Pat. No. 6,198,643 and its pending, soon to be issued, CIP case (Ser. No. 09/856,289), etc.

For a single-ended interconnect, one assembly 210/120 is used per channel, while, for balanced interconnects, two assemblies 210/220 are used.

Prototype power cord wire 200 was assembled on a jig to the inner conductor wires 211 straight and tight, while the outer conductor wires 221 were hand-wrapped in the spiral fashion described above. Some test work was done on the wire 200 and is discussed more fully below in connection with FIG. 4C.

### Oscilloscope Screens (FIGS. 4A-C)

As can be seen in FIGS. 4A, 4B and 4C are oscilloscope pictures of test results done on the prototype cables for the speaker cable 1, the audio interconnect cable 100 and the power cord 200, respectively. As can be seen from comparing them, all of the cables or prototype wiring devices have nearly identical roll-off characteristics due to the similar wrap characteristics.

The oscilloscope pictures were done with a Howell QL camera using a test setup with a square wave generator (Heath IG18) with a forty-seven (47 kΩ) kilohm half-watt resistor in series with the oscilloscope (Goldstar OS3040 Digital storage scope) and the inner conductors 11/111/211 and channel “B,” and the outer wires 21/121/221 in series with channel “A” and ground. The resistor was used to defeat the ability of the square wave generator's ability to drive the cable 1/100/200 with sufficient current to “force” the wave form thru.

In each of these figures, the upper trace represents the pure square wave being input, while the lower trace represents the wave as transmitted by the respective cable or wire 1/100/200. The oscilloscope pictures show very little loss of original signal characteristics with respect to higher capacitance type wire assemblies.

With respect to the picture (FIG. 4C) for the power cord 200, it shows the capacitive effects on the signal, which is what reveals the roll-off of the leading edge. However, as discussed below, this characteristic does not establish the sound quality of the power cord. In doing the tests shown in FIGS. 4A & 4C, the speaker wire 1 terminated in spade lugs and was ten (10′) foot in length and included no spiral wrapped grounding, while the power cord was three (3′) feet in length but both still show substantially the same response characteristics.

### Discussion of Additional, Exemplary Variations

As noted above, the use of exactly four (4) conductors for both the inner wires 11/111/211 and the outer, spiral wound conductors 21/121/221 is preferred. The combinations of one, two, three wires, and so on up to eight conductors (for each primary conductor) and it was found that four (4) appeared to be the magic number, representing not just a difference of degree but one of kind. It is not yet clear why, but it appears that the fields surrounding the wire are affected less by the grouping of four. The spiral approach of using four and four (eight total) wires spiral wound and commonly electrically connected together at their ends was found to be dismal for either the speaker wire 1 or the audio interconnects 100. The same held true when the cables were just laid parallel to each other. (this would allow extreme inductive coupling to occur, along with its cancellation of the signal carried).

However, although some variation as to the number of conductors may be possible, it is absolutely necessary to have multiple, inner conductors, each separately insulated along their lengths but commonly electrically terminated at each of its opposite ends, and multiple outer conductors, each separately insulated along their lengths but commonly electrically terminated at each of its opposite ends.

From what has been seen to the date of filing the original provisional patent application, the cables' inductance (with four straight and four spiral wires) is partially eliminated by the crossing of the cables. The wrap is important to the sound of the cables when used as a speaker wire 1.

As noted above, the four inner straight conductors 11+ carry the signal and the outer wires 21+ carry the ground. It seems that the signal is “protected” by the grounded spirals around it as long as they don't appear as a shield as most coax cables are made.

The inventor also tried to wind the outer conductors as a tight, outer shield and it also was awful sounding. This may have been due to the fact that the outer wires were then much longer than the inner ones, causing not only capacitance but resistance problems as well.

In the case of power cords (FIG. 3) using a neutral and a ground, the outer wires are then a total of eight wires, four for the neutral and four for the ground. This works incredibly!

In the case of a two lead power cord, the standard four on four arrangement is used. This arrangement is used on the speaker wire setup. Interestingly enough the wire size for the speaker wire 1 and the power cord 200 ended up being fourteen (14 g) gauge, stranded wire made by Carol Wire Company. It was separated from a common pair and the four individual wires laid side by side and the four outer separates wound around. It seems that making the wire in a common jacket also does work (molding it like “zip” cord or standard A/C type lamp cord). It would appear that this has to do with capacitance, because, when the conductors are common in a jacket, they are capacitively coupled to each other. Loosely wound, there is a lot of air between them, reducing capacitance significantly.

The exception to all of this is the audio interconnect wires 100. They are preferably wound with a solid outer four wires and a stranded inner four wires.

A little “secret” a lot of wire manufacturers is that they do not want known how few actually listen to their wires when used, for example, as speaker wires. It is somewhat known that the majority of speaker and audio interconnect wires are made to look expensive, and therefore the price implies that their wire is better. However, this wire embodiments of this invention have been listened to extensively in its development and has repeatedly shown that they are superior to all others, although the manufacturing costs and ultimate sale price are expected to be much less than the “high line” wires of the prior art.

With respect to gauge of the wires used, and, as noted above, the cables (speaker 1 and power 200) preferably use fourteen (14) gauge stranded wire for the inner straight 11/211 and spiral wound outer 21/221. The inventor tried different gages but they gave poorer results (especially thicker wire).

The audio interconnects 100 preferably use approximately a twenty-two to twenty-four (22 to 24 g) gauge wire with what appears to be a nylon or plastic type insulation. The inventor has used a number of different wire types when developing the cables and currently the Consolidated Cable Company wire (their part #1721 with outer shield and covering removed) has been found to be preferred, but, of course, many other wires could be used.

It is noted that the preferred, detailed embodiments 1, 100 & 200 are a result of a great deal of trial and error, but the time and resources to conduct a truly scientific investigation have not yet been available.

It is also noted that oscilloscope, capacitor analyzing, inductance measuring and resistance measuring reveal virtually nothing about how a particular composite cable will sound in use. Analysis plus audio testing demonstrates the superior ability of the prior art cable to pass a square wave. The prior art cables do not sound great but measure theoretically great.

In contrast to the prior art cables, the embodiments of the present invention have lower capacitance than a lot of fully shielded wires of the prior art.

Lastly, all of the prototype builds are covered in black vinyl electrical tape. A number of different coverings were tested and the vinyl electrical tape cover was found then to be the best of the materials tested. Other alternative, covering materials are silk and cloth. Heat shrink tubing was the worst sounding, although the easiest and most economical to apply.

It is finally noted that there possibly are many, inter-associated variables and factors in make up the wiring devices of the present invention, and further study and scientific investigation may show other preferred specifications, but the foregoing disclosed ones are currently highly preferred.

For example, using a paper covering around the surrounding wires in substitution of or in addition to the electrical tape covering, preferably the former, has also been satisfactorily used and has allowed a even looser wrap of the surrounding wires, improving performance. To test the effect of different covering materials (paper along or rubber and paper used together), a test wire two and a half (2.5′) feet long was used and tested @ 1 khz.

With a rubber covering one hundred and forty-eight (148) henries was measured across the conductor groups to each other, and one hundred and sixty-six (166) picofarads was measured across the conductor groups to each other. Without the rubber covering (paper only) one hundred (160) henries was measured (the higher the more “invisible” the conductor groups are to each other) and one hundred and fifty-four (154) picofarads was measured (the lower the more “invisible” the conductor groups are to each other).

Thus, by removing the rubber covering, the outer layer of insulation which acts as the insulator of a capacitor, the overall capacitance is lowered. Removing the outer layer allows less coupling (inductively) and results in even less loss and is now considered preferred.

### Additional Comments

The currently preferred embodiments of the invention use, for example, an effectively over-all eight (8) gauge power cord using an internal complement of, for example, eight or twelve (8/12) individual fourteen (14) gauge wires.

It should be understood that the preferred embodiments of the present invention allow more of the AC signal to pass-through, unrestricted than, for example, the high-end esoteric power cords of the prior art evaluated using assignee's revealing CRT testing procedures. The preferred embodiments of the present invention are designed to power all types of, for example, audio and video components.

The inventor became increasingly aware of the harmful effects from noise filtering and frequency tailoring of many prior art power cords, especially when used in conjunction with assignee's commercial power units [see assignee's U.S. Pat. No. 6,198,643 (issued Mar. 6, 2001) and U.S. Pat. No. 6,493,244 (issued Dec. 10, 2002) and www.richardgrayspowercompany.com)]. These prior art “esoteric” power cords tended to “over-damp” the signal, causing high frequency roll-offs, a dulling of the sound and visual aberrations on video displays.

Many high-end, prior art cables are wrapped with pretty outer sleeves of various materials and webbing, such as heat-shrink tubing or rubber wrapped tightly around the core wire. The inventor hereof discovered that this can dramatically affect the performance of the wire, degrading the signal being transmitted. This condition, coupled with typically poor terminations, yields wire performance that deteriorates even further over time.

By contrast, the highest quality of the embodiments of the present invention preferably are terminated by hand, assuring the best connections with the least signal loss, and uses a loose sleeve composed of a material that in no way significantly affects electrical performance.

In testing/developing the embodiments of the present invention it became increasingly clear that in regards to audio, everyone hears differently. Were this not the case, there would probably exist only one type of amplifier, speaker, etc. In the case of video, people tend to agree more on a clear, well-defined picture. There may be slight differences in adjustments made to tint, color, brightness, etc., but even that will soon change with the incorporation of, for example, HDTV and the RGB input standard.

### Recommended Evaluation Procedures

The natural tendency is to evaluate power cords by plugging them into source components such as CD/DVD or preamp/processor because these are considered the most power sensitive equipment within an audio/video system. Whereas this is usually true with many esoteric prior art power cords, the inventor hereof has found that this same approach with the preferred embodiments of the present invention are believed to be flawed.

Contradicting this methodology, it is recommended first plugging the preferred embodiments of the power cords of the present invention into the amps, subwoofers and receivers to hear power delivery never before, it is believed, experienced. Once this has been done, it is further recommended to go upstream by installing the preferred embodiments on the preamp/processor to reinforce and confirm what has already been experienced, and then go further upstream in the power chain to include the DVD/CD players. On video one will find that projectors and plasmas that offer a replaceable power cord will benefit greatly by the increased power delivery of the preferred embodiments of the invention.

A fifteen (15) amp IEC connector standard removable power cord of a preferred, exemplary embodiment of the invention is designed to fit, for example, the RGPC™ “400” units as well as most electronic equipment. A twenty (20) amp IEC connector and removable power cord of a preferred, exemplary embodiment of the invention is designed to fit the RGPC™ “600S”, RGPC™ “1200S” and RGPC™ “Pole Pig”™ units (see www.richardgrayspowercompany.com for additional info on the “RPGC”™ products). It also currently fits a handful of power amplifiers from high-end manufacturers, such as those from Audio Research Corporation.

The currently most preferred, commercial embodiments of the present invention are provided in the following, exemplary models and lengths. An exemplary model with standard fifteen (15) amp IEC Connector—half (½) meter, one (1) meter, one and a half (1½) meters, two (2) meters, three (3) meters and three plus (3+) meter lengths. Likewise, a model with a heavy duty twenty (20) amp IEC connector may be provided in the same lengths, if so desired, etc.

All power cords of the invention of the best quality preferably are hand terminated by skilled technicians, for example, for the assignee, namely, Richard Gray himself, the inventor hereof, although mechanized approaches alternatively may be used for cost savings, etc., if so desired.

The exemplary specifications for assignee's current two products embodying principles of the present invention, sold in various lengths, are outlined below, as manufactured by New England Wire Technologies (www.newenglandwire.com) in Lisbon, N.H., formerly named New England Electrical Wire.”Version designation “N31-3,” combined twelve (12) conductor, three (3) prong/post, audio/visual/power cable, particularly for audio/video, AC signal or power connections and the like includes for example—
six (6), electrically conductive wires of effectively fourteen (14) awg (American Wire Gauge), forty-one/thirty (41/30), bare copper, twenty-second thousandths (0.022″, 0.020″ minimum) of an inch, with clear polyvinylchloride (pvc) insulator to one hundred and eighteenth (0.118″±0.004″) of an inch, outer diameter (OD) to UL AWM (American Wire Material) “10012” spec. for the ground/neutral post;
   and
six (6), electrically conductive wires of effectively fourteen (14) awg, forty-one/thirty (41/30), tinned copper, twenty-second thousandths (0.022″, 0.020″ minimum) of an inch, with clear polyvinylchloride (pvc) to one hundred and eighteenths (0.118″±0.004″) of an inch outer diameter (OD) to UL AWM“10012” specs. for the neutral/ground post.

These twelve (12) conductor wires then are combined together, for example, as follows—
spirally cable the six (6) tinned copper singles and two (2) of the bare copper singles around the remaining four (4) bare copper singles, pulled in parallel, stacked two over two (2×2) forming the electrical signal carrying core, paper tape fifty (50%) percent lap, and a second paper tape fifty (50%) percent lap on top of the other, with three hundredths (0.03″±0.030″ minimum) of an inch, with a matte gray polyvinylchloride (pvc) insulating jacket to five hundred and ninety-four (0.594″±0.020″) of an inch outer diameter (OD) to UL AWM “2570” specs., 80° C., 600V specs. for the active, varying, signal carrying prong/post, with the two, outer, spiral sets of four (4) wires each serving separately as the other two AC prong/posts (neutral/ground), with the spiraled wires being placed side-by-side but physically separated and equally spaced from one another, with each of the eight (8) separate wires forming a complete, spiral, three hundred and sixty (360°) degree encirclement about, for example, every eight (8″) inches of linear length of the wire core;
producing a “RU AWM “2570” 80° C., 600V, ‘E42481’” interconnect cable provided in bulk from the wire manufacture to ultimately form an interconnect device by having three (3), appropriate prong/posts connectors attached to each of the ends of a piece of the cable of a desired length.

Version designation “N31-30b-406-9up2” for a combined eight (8) conductor, two prong/post, audio/video/power cable, particularly for power amp(s) to audio speaker connections and for two prong/post, audio/video component connections and the like—
four (4), effectively fourteen (14) awg, forty-one/thirty (41/30), bare copper wire of twenty-two thousandths (0.022″±0.020″ minimum) of an inch, with a clear polyvinylchloride (pvc) to one hundred and eighteenths (0.118″±0.004″) of an inch outer diameter (OD) to UL AWM “10012” specs.; and
four (4), effectively fourteen (14) awg, forty-one/thirty (41/30) tinned copper wires, each twenty-two thousandths (0.022″±0.020″ minimum) of an inch, with clear polyvinylchloride (pvc) to one hundred and eighteen thousandths (0.118″±0.004″) of an inch outer diameter (OD) to UL AWM “10012” specs.

These eight (8) conductor wires then are combined together, for example, as follows—
spirally cable the four (4) tinned copper singles around the four (4) bare copper singles pulled in parallel, stacked two over two (2×2) forming the longitudinally extended, signal carrying post, paper tape, fifty (50%) percent lap, and a second paper tape fifty (50%) percent lap on top of the other, thirty-three thousandths (0.033″±0.030″ minimum) of an inch, each with a matte gray polyvinylchloride (pvc), insulating jacket to five hundred and ninety-four thousandths (0.594″±0.020″) of an inch outer diameter (OD) to UL AWM “2570” specs., 80° C., 600V, with the spiraled wires being placed side-by-side but physically separated and equally spaced from one another, with each of the four (4) separate wires forming a complete, spiral, three hundred and sixty (360°) degree encirclement about, for example, every eight (8″) inches of linear length of the wire core forming the neutral (ground) post at each end;
   producing a “RU AWM “2570” spec., 80° C., 600V, ‘E42481’” interconnect, cable provided, for example, in bulk from the wire manufacture to ultimately form an interconnect device by having two, appropriate prong/posts connectors attached to each of the ends of a piece of the cable of a desired length.

Of course the foregoing particular dimensions and other details generally are exemplary and are subject to great variation.

It is noted that the embodiments described herein in detail for exemplary purposes are of course subject to many different variations in structure, size, design, application and methodology. Because many varying and different, additional embodiments may be made within the scope of the inventive concepts herein taught, and because many modifications may be made in the embodiments herein detailed in accordance with the descriptive requirements of the law, it is to be understood that the details herein generally are to be interpreted as illustrative and not in a limiting sense.

1. An electrical wiring interconnect device for carrying AC voltage/current from one electrical device to another electrical device associated with an AC power source of at least about one hundred and ten (110) volts having at least two AC poles, comprising:
at least about four, longitudinally extended, core, electrical conductor wires juxtaposed and held together to form a longitudinally extended core having a first end and an opposed, second end, but electrically insulated from one another along their lengths but electrically joined at each of their respective ends to one another electrically attached to one electrical AC pole of an electrical interconnection at each of their ends;
at least one set of at least about four, additional electrical conductive wires spirally wound and positioned about said core, with all of the spiral wires being electrically insulated from one another along their lengths but electrically joined at each of their respective ends to one another electrically attached to a different electrical AC pole of an electrical interconnection at each of their ends; and
an outer covering covering over the combination of said core wires and said spiral wires along their lengths.

2. The electrical wiring interconnect device of claim 1, wherein there are:
exactly four core wires.

3. The electrical wiring interconnect device of claim 1, wherein there are:
exactly four spiral wires.

4. The electrical wiring interconnect device of claim 1, wherein there are:
exactly four core wires and exactly four spiral wires.

5. The electrical wiring interconnect device of claim 1, wherein there is three AC poles and wherein there is further included:
a second set of at least about four, additional electrical conductive wires spirally wound and positioned about said core, with all of the spiral wires being electrically insulated from one another along their lengths but electrically joined at each of their respective ends to one another electrically attached to a third electrical AC pole of an electrical interconnection at each of their ends, said second set of spiral wires being interleaved with said one set of spiral wires.

6. The electrical wiring interconnect device of claim 5, wherein:
one of said sets of spiral wires is connected to the AC neutral pole, while the other set of spiral wires is connected to the AC ground pole.

7. The electrical wiring interconnect device of claim 5, wherein there are:
exactly four core wires and exactly four spiral wires in each of said sets of spiral wires for a total of eight spiral wires, with each set being longitudinally spaced from one another in spiraling around said core.

8. The electrical wiring interconnect device of claim 1, wherein:
the overall length of said interconnect device is at least about one meter.

9. The electrical wiring interconnect device of claim 1, wherein:
said spiral wires are loosely wound about said core.

10. The electrical wiring interconnect device of claim 1, wherein:
said core wires carry the AC signal.

11. The electrical wiring interconnect device of claim 1, wherein:
said spiral wires are loosely wound about said core.

12. The electrical wiring interconnect device of claim 1, wherein:
said covering is loosely applied to and maintained over said spiral wires and said core wires without any shrink-wrap pressure on said spiral wires from said covering.

13. The electrical wiring interconnect device of claim 1, wherein:
said spiral wires are physically placed side-by-side from one another but also spaced from each other.

14. The electrical wiring interconnect device of claim 13, wherein:
each of said spiral wires make a complete, three hundred and sixty (360°) degree turn about every eight (8″) inches of linear length of said core wires.

15. A method of electrically wiring two devices together in an audio and/or video (audio/video) system, comprising the following steps:
(a) providing—for connection between two audio/video devices in the audio/video system which includes at least two electrical devices from the group consisting of an AC power source, a powered amplifier powerable from the AC power source and with an electrical signal carrying output for connection to an audio/video component, and an audio/video component with an electrical signal carrying input from the amplifier—an electrical wiring interconnect device for carrying AC voltage/current from one electrical device to the other electrical device associated with the AC power source of at least about one hundred and ten (110) volts having at least two AC poles, one of which is a signal carrying pole, comprising—
at least about four, longitudinally extended, core, electrical conductor wires juxtaposed and held together to form a longitudinally extended core having a first end and an opposed, second end, but electrically insulated from one another along their lengths but electrically joined at each of their respective ends to one another electrically attached to a signal carrying, electrical AC pole of an electrical interconnection at each of their ends;
at least one set of at least about four, additional electrically conductive wires spirally wound and positioned about said core, with all of the spiral wires being electrically insulated from one another along their lengths but electrically joined at each of their respective ends to one another electrically attached to a different electrical AC pole of an electrical interconnection at each of their ends; and
an outer covering covering over the combination of said core wires and said spiral wires along their lengths; and
(b) attaching the signal carrying, electrical AC poles between the signal carrying connections of two of said two electrical devices and connecting the other two poles together.

16. The method of electrically wiring two devices together in the audio/video system of claim 15, wherein there is further included the step in step “b” of:
attaching the powered amplifier to an audio speaker.

17. The method of electrically wiring two devices together in the audio/video system of claim 15, wherein there is further included the step in step “b” of:
attaching the powered amplifier to an audio/video component.

18. The method of electrically wiring two devices together in the audio/video system of claim 15, wherein there is further included the step in step “a” of:
including a second set of at least about four, additional electrically conductive wires spirally wound and positioned about said core, totaling at least about eight conductive, spiral wires with all of the spiral wires being electrically insulated from one another along their lengths but with each set electrically joined at each of their respective ends to one another electrically attached to a different electrical AC poles for separate electrical interconnection at each of their ends, there then being a total of three, different electrical pole prongs at each end when combined with the core wires.

19. The method of electrically wiring two devices together in the audio/video system of claim 18, wherein there is further included the step in step “b” of:
attaching the powered amplifier to the AC power source.

20. The method of electrically wiring two devices together in the audio/video system of claim 18, wherein there is further include the step in step “b” of:
attaching the AC power source to an AC wall outlet.

21. The method of electrically wiring two devices together in the audio/video system of claim 18, wherein there is further included the step in step “b” of:
attaching the audio/video component to the AC power source.
